(19) United States
(12) Patent Application Publication
(10) Pub. No.: US 2022/0272066 A1
(43) Pub. Date: Aug. 25, 2022

(54) NOTIFICATION CONDITION CUSTOMIZED MESSAGE PROCESSING DEVICE AND METHOD

(71) Applicants: Jae Ho CHOI, Seoul (KR); Hyun Kyu CHOI, Seoul (KR); Seo Hyun CHOI, Seoul (KR); Delta PDS CO., LTD., Seoul (KR)

(72) Inventors: Jae Ho CHOI, Seoul (KR); Hyun Kyu CHOI, Seoul (KR); Seo Hyun CHOI, Seoul (KR)

(73) Assignees: Jae Ho CHOI, Seoul (KR); Hyun Kyu CHOI, Seoul (KR); Seo Hyun CHOI, Seoul (KR); Delta PDS CO., LTD., Seoul (KR)

(21) Appl. No.: 17/678,628

(22) Filed: Feb. 23, 2022

(30) Foreign Application Priority Data
Feb. 25, 2021 (KR) 10-2021-0025718
Feb. 25, 2021 (KR) 10-2021-0025726
Feb. 18, 2022 (KR) 10-2022-0021613

(51) Int. Cl. H04L 51/224; H04L 12/18; H04L 51/00

(52) U.S. Cl. CPC H04L 51/24; H04L 12/1818; H04L 51/16

(57) ABSTRACT

A notification condition customized message processing device includes a chat room opening unit which opens a chat room connected to a plurality of user terminals, an individual notification condition setting unit which sets individual notification conditions depending on a user status and a message type for each of the plurality of user terminals, a chat message processing unit which receives a chat message from a chat sending user terminal through the chat room and inserts the chat message into a message thread associated with the chat room, a chat message notification method determining unit which determines at least one chat receiving user terminal and determines a notification method for the chat message based on individual notification conditions for each of the at least one chat receiving user terminals, and a chat message notification unit which notifies each of the at least one chat receiving user terminals of the chat message.

### CROSS-REFERENCE TO PRIOR APPLICATIONS

This application claims priority to Korean Patent Application No. 10-2021-0025718 (filed on Feb. 25, 2021), 10-2021-0025726 (filed on Feb. 25, 2021), and 10-2022-0021613 (field on Feb. 18, 2022), which are all hereby incorporated by reference in their entirety.

### BACKGROUND

The present disclosure relates to a notification condition customized message processing technology, and more specifically, to a notification condition customized message processing device and method capable of providing a notification regarding a chat message in a chat room in accordance with notification conditions for each chat receiving user.

Internet messengers are applications that transmit a message including text or graphics between users and may be implemented as a chat room in which a plurality of users participates. In an embodiment, Internet messengers may include a mobile messenger performed in a mobile environment (e.g., a mobile phone) and may include, for example, KakaoTalk, Line, WeChat, and Facebook messenger.

In order to support communication of a user with the other party through messages, an Internet messenger may notify the user of whether the other party has checked messages and a status of the other party's participation in a chat room. In addition, in order to support communication of the other party with the user through messages, the Internet messenger may notify the user of reception of a message by the other party.

### PRIOR ART DOCUMENT

### Patent Document

Korean Patent Application No. 10-2019-0125288 (6 Nov., 2019)
Korean Patent Application No. 10-2020-0020192 (26 Feb., 2020)

### SUMMARY

An embodiment of the present disclosure is to provide a notification condition customized message processing device and method capable of providing a notification regarding a chat message in a chat room in accordance with notification conditions for each chat receiving user.

An embodiment of the present disclosure is to provide a notification condition customized message processing device and method capable of notifying a chat message by setting individual notification conditions depending on a user status and a message type and determining a chat message notification method based on individual notification conditions for each of at least one chat receiving user terminal.

An embodiment of the present disclosure is to provide a notification condition customized message processing device and method capable of delaying notification of a chat message during time other than working hours by setting individual notification conditions based on working hours of a user and a message type.

In embodiments, a notification condition customized message processing device includes a chat room opening unit which opens a chat room connected to a plurality of user terminals, an individual notification condition setting unit which sets individual notification conditions depending on a user status and a message type for each of the plurality of user terminals, a chat message processing unit which receives a chat message from a chat sending user terminal among the plurality of user terminals through the chat room and inserts the chat message into a message thread associated with the chat room, a chat message notification method determining unit which determines at least one chat receiving user terminal among the plurality of user terminals and determines a notification method for the chat message based on individual notification conditions for each of the at least one chat receiving user terminals, and a chat message notification unit which notifies each of the at least one chat receiving user terminals of the chat message through the chat message notification method.

The individual notification condition setting unit may convert a notification available time in the individual notification conditions into a reference time zone based on a time zone to generate a notification reference time, tag the notification reference time to the chat message, and insert the chat message into a notification message list.

The individual notification condition setting unit may bring a time zone of a corresponding chat receiving user terminal in the process of conversion.

The individual notification condition setting unit may analyze the notification message list and delay provision of the chat message until the notification reference time is met.

The individual notification condition setting unit may set the individual notification conditions by determining the user status based on user's working hours and determining the message type based on a general message, a mention message, an object message, or a response message.

The individual notification condition setting unit may set the individual notification conditions based on the number of unread chat messages in the chat room.

The chat message processing unit may immediately provide the chat message to the chat room regardless of the individual notification conditions.

The chat message notification method determining unit may determine a main notification method and an auxiliary notification method for the chat message based on the individual notification conditions, wherein the main or auxiliary notification method may be optional.

The chat message notification method determining unit may set whether a push notification is present and whether a push notification is delayed as the main notification method and set whether a text message based on cellular transmission is sent and whether an e-mail is sent as the auxiliary notification method.

The chat message notification method determining unit may include the number of unread chat messages along with description of the chat room in a push message through the push notification.

The individual notification condition setting unit may set individual task alarm conditions for each of at least one task object composed of a task orderer, a task handler, details of a task, a task status, and a task deadline in the message thread.

The individual notification condition setting unit may set the individual task alarm conditions based on at least one of a no-change time of the task status with respect to each of the at least one task object and a remaining time of the task deadline.

The chat message notification method determining unit may update the individual task alarm conditions such that the task handler is continuously notified of the at least one task object until the task status is completed.

In embodiments, a notification condition customized message processing method includes a chat room opening step for opening a chat room connected to a plurality of user terminals, an individual notification condition setting step for setting individual notification conditions depending on a user status and a message type for each of the plurality of user terminals, a chat message processing step for receiving a chat message from a chat sending user terminal among the plurality of user terminals through the chat room and inserting the chat message into a message thread associated with the chat room, a chat message notification method determining step for determining at least one chat receiving user terminal among the plurality of user terminals and determining a notification method for the chat message based on individual notification conditions for each of the at least one chat receiving user terminals, and a chat message notification step for notifying each of the at least one chat receiving user terminals of the chat message through the chat message notification method.

### BRIEF DESCRIPTION OF THE DRAWINGS

FIG. 1 is a view illustrating a notification condition customized message processing system according to an embodiment of the present disclosure.

FIG. 2 is a view illustrating a physical configuration of a notification condition customized message processing device in FIG. 1.

FIG. 3 is a view illustrating a functional configuration of the notification condition customized message processing device in FIG. 1.

FIG. 4 is a flowchart illustrating a notification condition customized message processing procedure in the notification condition customized message processing device in FIG. 1.

FIG. 5 is a flowchart illustrating a procedure of processing a message customized for task alarm conditions for a task object in the notification condition customized message processing device in FIG. 1.

FIG. 6 is a view illustrating a process in which the notification condition customized message processing device of FIG. 1 provides an alarm chat message to a related chat room through a user terminal.

FIGS. 7A and 7B are views illustrating a process of setting a notification time condition among individual notification conditions and providing a push message according to an embodiment.

FIG. 8 is a view illustrating an exemplary method of notifying a chat message in the notification condition customized message processing device according to an embodiment.

### DETAILED DESCRIPTION

The description of the present disclosure is merely an example for structural or functional explanation, and therefore, the scope of the present disclosure should not be construed as being limited by the embodiments described in the text. That is, since the embodiments can be variously embodied and have various forms, the scope of the present disclosure should be understood to include equivalents capable of realizing technical ideas. Also, since the purpose or effect set forth in the present disclosure is not intended imply that to the specific embodiment, the scope of the present disclosure should not be construed as being limited thereto.

Meanwhile, the meaning of the terms described in the present application should be understood as follows.

The terms such as “the first”, “the second”, and the like, are intended to distinguish one element from another, and the scope of the right should not be limited by these terms. For example, the first component may be referred to as the second component, and similarly, the second component may also be referred to as the first component.

It is to be understood that when an element is referred to as being “connected” to other element, it may be directly connected to the other element, but there may also be other elements in between. On the other hand, when an element is referred to as being “directly connected” to other element, it should be understood that there is no other element in between. On the other hand, other expressions that describe the relationship between elements, that is, “between—” and “just between—” or “adjacent to—” and “directly adjacent to—” should be interpreted likewise as well.

The singular expressions should be understood to include plural expressions unless the context clearly dictates otherwise. It is also to be understood that the terms “comprise”, “include”, “have”, and the like, are to designate the presence of practiced features, numbers, steps, operations, elements, parts, or combinations thereof, but do not preclude the presence or addition, possibility of one or more other features, numbers, steps, operations, elements, parts, or combinations thereof.

In each step, the identification code (e.g., a, b, c, etc.) is used for convenience of explanation, but the identification code does not describe the order of each step, and unless otherwise explicitly stated, it may occur differently from the stated order. That is, each of steps may occur in the same order as described, may also be performed substantially at the same time, and may be performed in reverse order.

All terms used herein have the same meaning as commonly understood by one of ordinary skill in the art to which this disclosure belongs, unless otherwise defined. Terms defined in commonly used dictionaries should be interpreted to be consistent with meaning in the context of the related art and cannot be interpreted as having ideal or overly formal meaning unless explicitly defined in the present application.

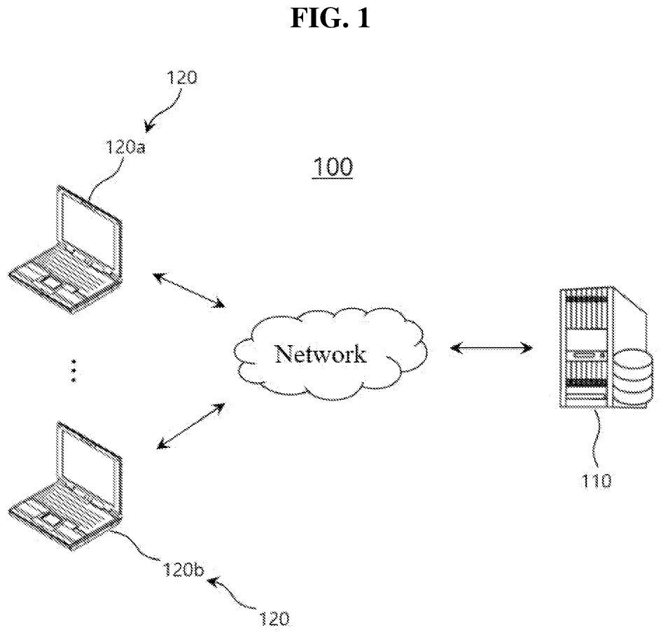

FIG. 1 is a view illustrating a notification condition customized message processing system according to an embodiment of the present disclosure.

Referring to FIG. 1, the notification condition customized message processing system 100 may include a notification condition customized message processing device 110 and a plurality of user terminals 120 which are connected through a network.

The notification condition customized message processing device 110 corresponds to a computing device that can be connected to the plurality of user terminals 120 through a network. In an embodiment, the notification condition customized message processing device 110 may manage a message thread that is a group of messages transmitted from the plurality of user terminals 120. Here, a message thread may be implemented as a chat room of an Internet messenger. For example, the notification condition customized message processing device 110 may manage a plurality of message threads, each message thread may include a plurality of user terminals 120, and the notification condition customized message processing device 110 may manage the plurality of user terminals 120 for each message thread.

The notification condition customized message processing device 110 may provide a chat room in which the plurality of user terminals 120 can participate. To this end, the notification condition customized message processing device 110 may provide a chat function and an interface such as an application for allowing users to use a chat room in advance to the plurality of user terminals 120 and cause the interface to be installed. The notification condition customized message processing device 110 may provide a chat room function, execute a notification condition customized procedure for a chat message, and manage a memory from which or to which information is read or written in such a procedure.

The plurality of user terminals 120 corresponds to computing devices that can be connected to the notification condition customized message processing device 110 through a network and may be, for example, various terminals implemented as desktop computers, laptop computers, tablet PCs, or smartphones. In an embodiment, a first user terminal 120a may correspond to a mobile terminal and may be connected to the notification condition customized message processing device 110 through cellular communication or Wi-Fi communication. In another embodiment, a second user terminal 120b may correspond to a desktop computer and may be connected to the notification condition customized message processing device 110 through the Internet.

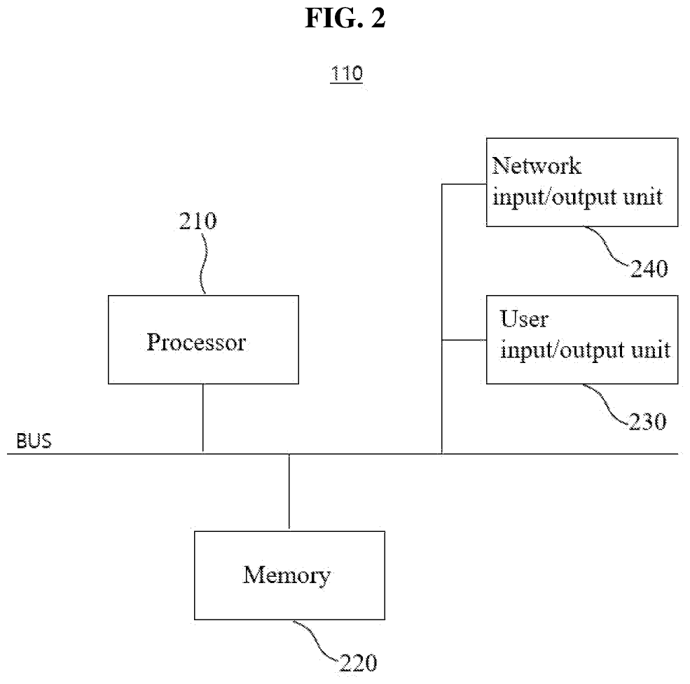

FIG. 2 is a view illustrating a physical configuration of the notification condition customized message processing device in FIG. 1.

Referring to FIG. 2, the notification condition customized message processing device 110 may include a processor 210, a memory 220, a user input/output unit 230, and a network input/output unit 240.

The processor 210 may execute a notification condition customized message providing procedure according to an embodiment of the present disclosure, may manage the memory 220 from which or to which information is read or written in this procedure, and schedule synchronization time between a volatile memory and a non-volatile memory in the memory 220.

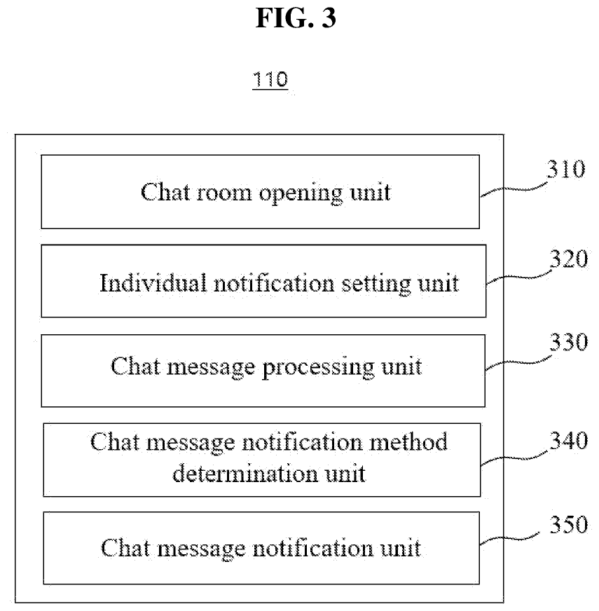

The processor 210 may control the overall operation of the notification condition customized message processing device 110 and may be electrically connected to the memory 220, the user input/output unit 230, and the network input/output unit 240 to control data flow therebetween. The processor 210 may be implemented as a central processing unit (CPU) of the notification condition customized message processing device 110. The operation of the processor 210 will be described in more detail later with reference to FIG. 3.

The memory 220 may include an auxiliary storage device implemented as a non-volatile memory, such as a solid state disk (SSD) or a hard disk drive (HDD), and used to store data required for the notification condition customized message processing device 110 and may include a main storage device implemented as a volatile memory such as random access memory (RAM). In this manner, the memory 220 may be implemented as a volatile memory and a non-volatile memory, and if the memory 220 is implemented as a non-volatile memory, may be implemented to be connected through a hyperlink.

The user input/output unit 230 includes an environment for receiving a user input and an environment for outputting specific information to the user and may include, for example, an adapter such as a mouse, a trackball, a touch pad, a graphic tablet, a scanner, a touch screen, a keyboard, or a pointing device or may include an input device connected thereto and an output device including an adapter such as a monitor or a touch screen. In an embodiment, the user input/output unit 230 may correspond to a computing device accessed through remote access, and in such a case, the notification condition customized message processing device 110 may serve as a server.

The network input/output unit 240 includes an environment for connecting to the user terminals 120 through a network and may include, for example, an adapter for local area network (LAN) communication.

The notification condition customized message processing device 110 may receive various user signals through the user input/output unit 230 or the network input/output unit 240.

FIG. 3 is a view illustrating a functional configuration of the notification condition customized message processing device in FIG. 1.

Referring to FIG. 3, the notification condition customized message processing device 110 may perform notification condition customized message processing through the processor 210. To this end, the processor 210 may include a chat room opening unit 310, an individual notification condition setting unit 320, a chat message processing unit 330, a chat message notification method determination unit 340, and a chat message notification unit 350.

However, the processor 210 according to an embodiment of the present disclosure does not necessarily include all of the aforementioned components at the same time, and according to each embodiment, some of the aforementioned components may be omitted and the processor 210 may optionally include some or all of the aforementioned components.

The chat room opening unit 310 may open a chat room connected to the plurality of user terminals 120. Here, the plurality of user terminals 120 may include a chat sending user terminal and at least one chat receiving user terminal. First, the chat room opening unit 310 may receive information on a plurality of users from the user terminals 120, and store, manage, and update user information of users participating in a chat.

In addition, the chat room opening unit 310 may create a user group upon receiving a request for creating a user group for a chat room from a user, and store and manage information on the name of each user group, user group classification criteria, members, and the like, identification information of a chat room matching each user group, information on classification of users by group, and authority management of each user or each user group, and the like.

The chat room opening unit 310 may open a chat room in which some or all of chat participants participate using user information collected through the above-described procedure and user group information generated using the user information.

The individual notification condition setting unit 320 may set individual notification conditions depending on a user status and a message type for each of the plurality of user terminals 120. The individual notification condition setting unit 320 may set individual notification conditions for each of the plurality of user terminals 120 in order to notify chat messages received through a chat room when the chat room is opened. Here, a notification collectively refers to a series of processes for enhancing a rate of participation in a chat through a chat room by reminding chat participants of a progress status regarding chat messages. A notification condition refers to at least one reference condition for determining whether notification regarding at least one chat message is necessary. Individual notification conditions may be set by a chat room establishers or a chat room participant associated with each of the plurality of user terminals 120. Chat receiving users may set individual notification conditions including notification available time of a chat message according to their circumstances. The users may set notification conditions such that a notification of a chat message is provided at a desired time.

The individual notification condition setting unit 320 may convert a notification available time included in individual notification conditions into a reference time zone based on a time zone to generate a notification reference time, tag the notification reference time to a chat message, and insert the same to a notification message list. The individual notification condition setting unit 320 may bring a time zone of a corresponding chat receiving user terminal 120 in the process of conversion, analyze the notification message list, and delay provision of a chat message until the notification reference time is met. Here, the time zone corresponds to a local time that is a reference time in performing a specific task. The individual notification condition setting unit 320 may detect the current time based on the region in which the corresponding chat receiving user terminal 120 is located as a time zone of the corresponding chat receiving user terminal 120.

In one embodiment, the individual notification condition setting unit 320 may detect a time zone based on the local time of the corresponding chat receiving user terminal 120 if a request for fixing a time zone received from the corresponding chat receiving user terminal 120 is not confirmed and may detect a time zone based on the request for fixing if the request is confirmed. More specifically, the individual notification condition setting unit 320 may check whether a request for fixing the time zone is received from the corresponding chat receiving user terminal 120, detect the current time of the region where the chat receiving user terminal 120 is located as a time zone of the chat receiving user terminal 120 if the request is not received, and detect a local time based on a specific reference time included in the request as a time zone of the corresponding chat receiving user terminal 120 if the request is received. For example, when a user is in New York, USA due to a business trip, the local time of the user terminal 120 associated with the corresponding chat receiving user may differ from a reference time (e.g., domestic current time) set by the individual notification condition setting unit 320. Thus, the individual notification condition setting unit 320 may detect the local time of New York as a time zone when there is no time zone fixing request from the corresponding chat receiving user terminal 120, and if there is a time zone fixing request including information on a specific local time predetermined by the corresponding chat receiving user (for example, a request for fixing a time zone to 11:00 in New York or 10:00 in Korea), determine the local time as a time zone. The individual notification condition setting unit 320 may generate a notification reference time by converting the notification available time set for the corresponding chat receiving user terminal 120 into a reference time zone based on the time zone. Here, a user individual notification condition may be set in advance to a specific time period (e.g., from 09:00 to 18:00 in local time of the region where the user terminal 120 is located) at the request of the corresponding chat receiving user terminal 120. In an embodiment, the individual notification condition setting unit 320 may calculate a chat message notification reference time of the corresponding chat receiving user terminal 120 based on the local time of the detected time zone such that the individual notification condition of the corresponding chat receiving user terminal 120 automatically matches working hours (from 09:00 to 18:00 based on the domestic time) of the user.

The individual notification condition setting unit 320 may set individual notification conditions by determining a user status based on working hours of a user and determining a message type based on a general message, a mention message, an object message, or a response message. In an embodiment, the individual notification condition setting unit 320 may set individual notification conditions by determining user statuses for working hours and non-working hours for each user. The individual notification condition setting unit 320 may set individual notification conditions such that a notification regarding a chat message is immediately provided to a corresponding user terminal during working hours of the corresponding user and provision of a chat message is delayed until a notification reference time is met during time other than the working hours. The individual notification condition setting unit 320 may set individual notification conditions depending on a message type. Message types may include a general message, a mention message, an object message, and a response message. The general message refers to a text message for which a chat message recipient is not specified in a chat room. The mention message refers to a message for which a chat message recipient is specified in a chat room. The object message is a binary message including an object such as a task or an image and may include a task handler designated message and a task handler non-designated message. The response message is a message of interest for an existing message and refers to, for example, “like”, “happy”, etc.

In an embodiment, the individual notification condition setting unit 320 may set individual notification conditions depending on a chat message type in a chat room. The individual notification condition setting unit 320 may set an immediate individual notification time or a delayed individual notification time depending on the presence or absence of a user-specified mention message associated with the corresponding user terminal 120 in a chat room. That is, the individual notification condition setting unit 320 may set individual notification conditions in association with notification urgency based on the presence of a user-specified mention message.

The individual notification condition setting unit 320 may set individual notification conditions based on the number of unread chat messages in a chat room. The number of unread chat messages may be included in individual notification conditions such that a notification message is provided to a user associated with each of the plurality of user terminals 120 connected to a chat room when the number of unread messages reaches a specific number. For example, when the number of unread chat messages in individual notification conditions is set to 10 or more in a user terminal 120, generation of a push message through push notification may be delayed until 10 or more unread chat messages are generated, and when generated, a push message related to chat messages may be provided to the corresponding user terminal 120.

The chat message processing unit 330 may receive a chat message from a chat sending user terminal among the plurality of user terminals 120 through a chat room and insert a chat message into a message thread associated with the chat room. Here, the chat message may include the chat sending user and message content, and in one embodiment, may further include at least one of a message sending time and a message type (e.g., a general message, a mention message, an object message, a response message, or the like).

When the chat message is inserted, the chat message processing unit 330 may provide the inserted chat message to at least one chat receiving user terminal except for the chat sending user terminal among the plurality of user terminals 120 through the chat room. When the chat message is inserted, the chat message processing unit 330 may immediately provide the chat message to the chat room regardless of individual notification conditions. For example, the chat message processing unit 330 may immediately provide the inserted chat message to each of chat receiving users other than chat receiving users who have immediately checked the inserted chat message and the chat sending user in a state in which the chat room is opened such that the other chat receiving users can respond to the message.

The chat message processing unit 330 may provide the number of unread chat messages that have not been checked by a user through a message unread count indicating information on messages that the user has not yet read. In an embodiment, the chat message processing unit 330 may detect the number of unread chat messages that are not checked by a user whenever a chat message is inserted and reflect the detected number in the message unread count. The chat message processing unit 330 may perform message unread counting and provide the number of unread chat messages to the corresponding user terminal 120. The number of unread chat messages may be calculated by subtracting the number of chat messages checked by the corresponding user from the total number of chat messages received by the corresponding user terminal through the chat room. That is, when accumulated chat messages are read by the user corresponding to the chat messages, the chat message processing unit 330 may count the number of read chat messages in real time. In addition, the chat message processing unit 330 may reduce a final accumulated number of unread chat messages by the number of read chat messages.

In an embodiment, the chat message processing unit 330 may add visual marking to some messages in the process of providing chat messages to distinguish message types such as a general message, a mention message, an object message, and a response messages. In an embodiment, the chat message processing unit 330 may add visual marking to some of corresponding messages in the process of providing chat messages to distinguish a normal chat message from an urgent chat message. Here, the chat message processing unit 330 may classify chat messages into a normal chat message and an urgent chat message according to presence of a user-specified mention message.

The chat message notification method determination unit 340 may determine at least one chat receiving user terminal 120 among a plurality of user terminals and determine a chat message notification method based on individual notification conditions for each of the at least one chat receiving user terminal 120. The chat message notification method determination unit 340 may optionally determine a main notification method and an auxiliary notification method for chat messages based on individual notification conditions. The chat message notification method determination unit 340 may set providing or non-providing a push notification and delaying a push notification as a main notification method and may set sending a text message and sending e-mail based on cellular transmission as an auxiliary notification method. The chat message notification method determination unit 340 may include the number of unread chat messages along with description of a chat room in a push message through a push notification.

The notification condition customized message processing device 110 may allow each user to individually set notification conditions and a notification method according to a user status and a message type. The notification condition customized message processing device 110 may separately set presence or absence of a push notification and delay of a push notification for working hours and non-working hours for each message type and may also separately set presence or absence of an auxiliary notification using a text message or e-mail. For example, individual notification conditions and a chat message notification method may be set as shown in Table 1 below.

TABLE 1

| | Working hours | Non-working hours |
|---|---|---|
| Normal message | Push notification ◯ | Push notification X, text |
| User specified mention | Push notification ◯, | Push notification delay, |
| general message | e-mail | e-mail |
| Object message | Push notification ◯ | Push notification X, text |
| Task handler specified | Push notification ◯, | Push notification delay, |
| mention object message | e-mail | text |
| Response message | Push notification ◯ | Push notification delay |

The individual notification condition setting unit 320 may set individual task alarm conditions for each of at least one task object composed of a task orderer, a task handler, details of a task, a task status, and a task deadline in a message thread. Here, the task status is a summary of a progress status of each processing step of a task and may include “new”, “in progress”, “finished” and “confirmed”. “New” is a newly generated task object and indicates a task object for which a response from a task handler has not been received. “In progress” indicates a state in which a response to the corresponding task object has been received from a task handler and corresponds to a situation in which the task handler is processing the corresponding task object. “Finished” indicates that a task handler has completed the corresponding task object and corresponds to a state of waiting for a response to completion of the task from the task handler, and “confirmed” indicates a state in which the task orderer has confirmed a completed task of a task handler.

The individual notification condition setting unit 320 may set individual work alarm conditions based on at least one of a task state and a task deadline. The individual notification condition setting unit 320 may set individual task alarm conditions based on at least one of no-change time of a task status for each of at least one task object and the remaining time of a task deadline. For example, individual task alarm conditions regarding each of at least one task object that needs to be notified may be set from the day after a task status has become “new” until the task status changes to “in progress” in the case of a task status of “new”, from the day before a task deadline until a task status changes to “finished” in the case of a task status of “in progress”, and from the day after a task status has changed to “finished” until the task status changes to “confirmed” in the case of a task status of “finished”.

The individual notification condition setting unit 320 may set individual task alarm conditions such that a task status is determined to require an alarm when the task status does not correspond to a finished status among a plurality of task statuses. For example, the individual notification condition setting unit 320 may set individual task alarm conditions such that it is determined that an alarm is necessary if the task status of each task object corresponds to “new”, “in progress” or “finished” and it is determined that an alarm is not necessary if the task status of each task object corresponds to “confirmed”. The individual notification condition setting unit 320 may update individual task alarm conditions such that a task handler can be continuously notified of at least one task object until a task status is completed.

The chat message notification unit 350 may notify each of at least one chat receiving user terminal 120 of a chat message through a chat message notification method. The chat message notification unit 350 may generate a push message regarding a chat message for each of the at least one chat receiving user terminal 120 based on the notification method. When there is a plurality of chat receiving user terminals 120, the chat message notification unit 350 may process a corresponding push message according to individual notification conditions of each chat receiving user terminal.

In one embodiment, the chat message notification unit 350 may check a chat receiving user of a chat room and cause the corresponding chat receiving user terminal 120 to process a push message regarding a chat message based on a notification method according to individual notification conditions set by the corresponding chat receiving user. The chat message notification unit 350 may analyze a notification message list and delay provision of a chat message until a notification reference time is met. That is, a chat message may be provided to the chat room in real time, and a push message regarding the chat message may be delayed until the notification reference time set by the user is met and then provided. The notification message list may include a push message regarding a chat message and a push notification reference time of the push message. Here, the push notification reference time may be derived from an individual push notification time based on the time zone of the corresponding user terminal 120.

The chat message notification unit 350 may provide a push message to the corresponding user terminal 120 in accordance with the time zone of the corresponding user terminal 120 to notify the user terminal 120 that the chat message has been provided to the chat room. The chat message notification unit 350 may delay adding the push message to the corresponding message thread until the push notification reference time of the corresponding chat receiving user is met based on the time zone. In one embodiment, the chat message notification unit 350 may temporarily store the push message in the memory if the push message generation time does not correspond to the notification reference time set in the user terminal 120, and add the push message to the message thread corresponding to the chat room associated with the push message at a time (e.g., 09:00) when the notification reference time set in the user terminal 120 is met.

The chat message notification unit 350 includes a link related to the chat message in the chat room in the push message such that the user can immediately access the chat message through the push message. In one embodiment, the chat message processing unit 350 may temporarily store at least one generated push message until a first time and simultaneously or sequentially add push messages temporarily stored until the first time to related message threads at a second time. For example, the chat message notification unit 350 may simultaneously add push messages temporarily stored and collected in the memory from 00:00 to 24:00 of the previous day based on the domestic time to at least one related message thread at 09:00 of the next day. In an embodiment, the chat message notification unit 350 may perform the above process based on the time zone of the corresponding user terminal 120. For example, the chat message notification unit 350 may simultaneously add push messages temporarily stored and collected in the memory from 00:00 to 24:00 of the previous day based on the local time of the region in which the corresponding user terminal 120 is located to at least one related message thread at 09:00 of the next day based on the local time.

When there is a plurality of chat receiving user terminals 120, the chat message notification unit 350 may detect individual notification conditions of each chat receiving user terminal and generate a push message therefor. In one embodiment, when there is a plurality of chat receiving user terminals 120, the chat message notification unit 350 may detect a time zone of each of the plurality of user terminals and delay provision of a push message until an intersection time of individual push notification times of the user terminals. For example, if the time zones of a plurality of user terminals participating in a chat room do not match, the chat message notification unit 350 may detect the time zones, determine an intersection time (09:00 to 10:00 based on the domestic time) in which individual push notification times (e.g., 09:00 to 21:00 based on the domestic time in the case of a terminal A, and 09:00 to 21:00 based on New York time (22:00 to 10:00 based on the domestic time) in the case of a terminal B) overlap, and delay provision of a push message until the intersection time begins.

The chat message notification unit 350 may process a push message according to the number of unread chat messages in a chat room included in individual notification conditions. Here, the push message may include the number of unread chat messages along with description of the chat room. The chat message notification unit 350 may delay generation of a push message or delay provision of a generated push message until the number of unread chat messages satisfies set individual notification conditions. For example, when the number of unread chat messages is set to 10 or more as an individual notification condition in the corresponding user terminal, the chat message notification unit 350 may notify the user terminal of a chat message by providing a push message until 10 or more unread chat messages are generated in the corresponding user terminal. The chat message notification unit 350 may generate a push message including the number of unread chat messages along with description of the chat room and provide the same to the corresponding user terminal 120. In this case, the chat message notification unit 350 may also provide information on an access path or location to each unread chat message such that unread chat messages can be checked when the number of unread chat messages is provided.

The chat message notification unit 350 may generate a push message based on presence or absence of a push notification as a chat message notification method, and may immediately provide the push message to the corresponding user terminal or provide the push message to the user terminal after delaying the same based on whether the push notification is delayed. In addition, when an auxiliary notification method is additionally selected as a chat message notification method, the chat message notification unit 350 may notify the corresponding user terminal of a chat message by sending a text message or e-mail.

The chat message notification unit 350 may generate a push message based on presence of a user-specified mention message in a chat room. Here, the push message may include urgency of a chat message along with description of the chat room. The chat message notification unit 350 may immediately provide a push message regarding the user-specified mention message to the corresponding user terminal 120 regardless of a notification available time included in individual notification conditions of the corresponding user. If there is a user-specified mention message in a chat room, the chat message notification unit 350 may determine the user-specified mention message as an urgent chat message and immediately provide a push message regardless of the notification available time of individual notification conditions set in the corresponding user terminal 120 to notify the corresponding user that the urgent chat message has arrived.

In an embodiment, the chat message notification unit 350 may manage at least one delayed push message through a plurality of user terminals 120 connected to a chat room. For example, the chat message notification unit 350 may support the corresponding user terminal such that it cancels at least one pending push message through a push message sending waiting box including push messages that are temporarily stored due to delay and are waiting to be sent or changes the state of the push message such that it can be immediately transmitted.

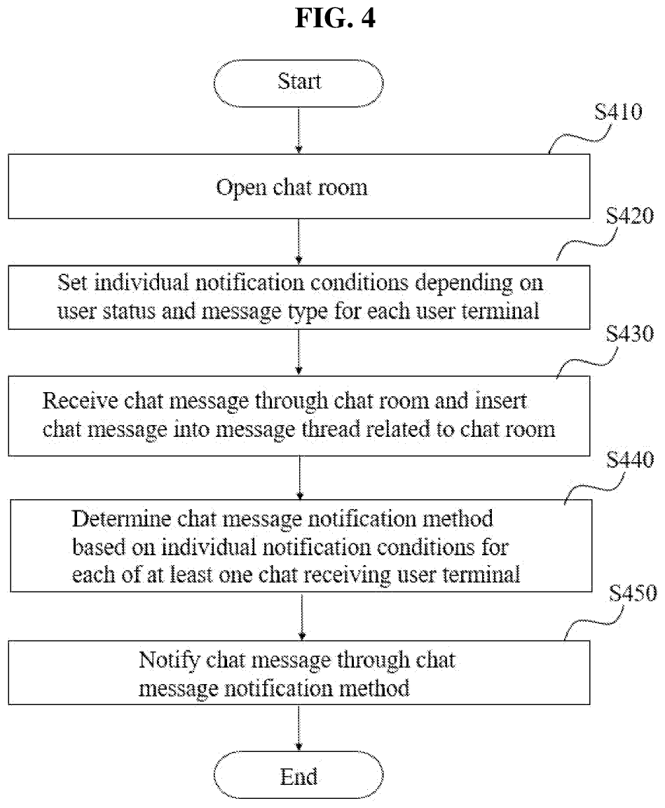

FIG. 4 is a flowchart illustrating a notification condition customized message processing procedure in the notification condition customized message processing device in FIG. 1.

Referring to FIG. 4, the notification condition customized message processing device 110 may open a chat room connected to a plurality of user terminals 120 (step S410).

In addition, the notification condition customized message processing device 110 may set individual notification conditions depending on a user status and a message type for each of the plurality of user terminals 120 (step S420). The notification condition customized message processing device 110 may convert a notification available time in the individual notification conditions of each user terminal into a time zone based reference time zone to generate a notification reference time, tag the notification reference time to a chat message, and insert it into a notification message list. Further, the notification condition customized message processing device 110 may set individual notification conditions by determining a user status based on working hours of a user and determining a message type based on a general message, a mention message, an object message, or a response message. In addition, the notification condition customized message processing device 110 may set individual task notification conditions for each of at least one task object composed of a task orderer, a task handler, details of a task, a task status, and a task deadline in a message thread.

The notification condition customized message processing device 110 may receive a chat message from a chat sending user terminal among the plurality of user terminals 120 through the chat room and insert the chat message into a message thread related to the chat room (step S430).

In addition, the notification condition customized message processing device 110 may determine at least one chat receiving user terminal among the plurality of user terminals 120 and determine a chat message notification method based on individual notification conditions for each of at least one chat receiving user terminal (step S440).

The notification condition customized message processing device 110 may notify each of the at least one chat receiving user terminal of the chat message through the chat message notification method (step S450).

In one embodiment of the present disclosure, the notification condition customized message processing device 110 can provide a push notification regarding a chat message related to a chat room through a chat message notification method in real time or by delaying the push notification according to individual notification conditions depending on a user status and a message type while providing the chat message in real time such that a chat receiving user can receive a push notification regarding a chat message at a desired time through a desired method for each message type, thereby improving convenience and efficiency of users participating in the chat room.

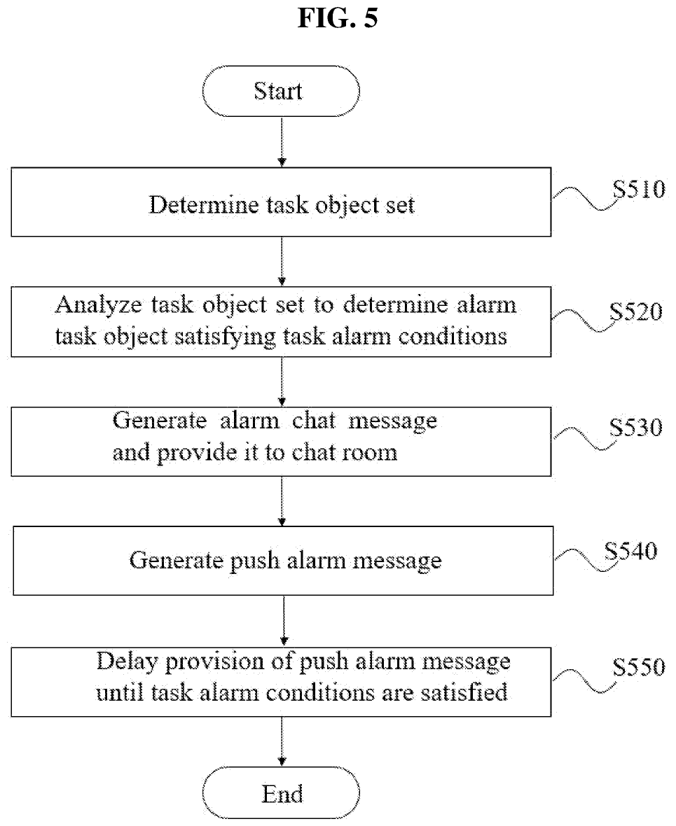

FIG. 5 is a flowchart illustrating a procedure of processing a message customized for task alarm conditions for a task object in the notification condition customized message processing device in FIG. 1.

Referring to FIG. 5, the notification condition customized message processing device 110 may determine a task object set including at least one task object (step S510). The at least one task object may be received through a chat room connected to a plurality of user terminals. Each of the at least one task object may include information on task participants, such as a task orderer and a task handler, details of a task, a task status, and a task deadline and may further include matters related to details of a task.

Further, the notification condition customized message processing device 110 may analyze the task object set to determine presence or absence of an alarm task object that satisfies task alarm conditions (step S520). The task alarm conditions may be at least one of no-change time of a task status and the remaining time of a task deadline.

In addition, the notification condition customized message processing device 110 may generate an alarm chat message regarding the alarm task object and provide the alarm chat message through a chat room (step S530). The alarm chat message may be provided to the chat room in real time. The alarm chat message may include a task object link that designates a task object in a message thread of the chat room and/or an alarm confirmation request from a task handler. The alarm chat message may be provided to the chat room along with a summary description of the task object. The notification condition customized message processing device 110 may calculate the number of times of providing the alarm chat message based on the task status and the task deadline and may adjust the number of times of providing the alarm chat message according to urgency of task progress. The alarm chat message may be provided to the chat room by the number of times calculated during the remaining time of the task deadline.

In addition, the notification condition customized message processing device 110 may generate a push alarm message regarding the alarm task object (step S540). The push alarm message may include a link to the corresponding alarm chat message in the chat room.

The notification condition customized message processing device 110 may check the task handler of the alarm task object and delay provision of the push alarm message until individual task alarm conditions set by the task handler are satisfied such that the task handler can receive the push alarm message at a desired time through a desired method (step S550).

In an embodiment of the present disclosure, the notification condition customized message processing device 110 can improve task efficiency by causing a push alarm message regarding an alarm task object to satisfy task alarm conditions set by the task handler and providing the push alarm message.

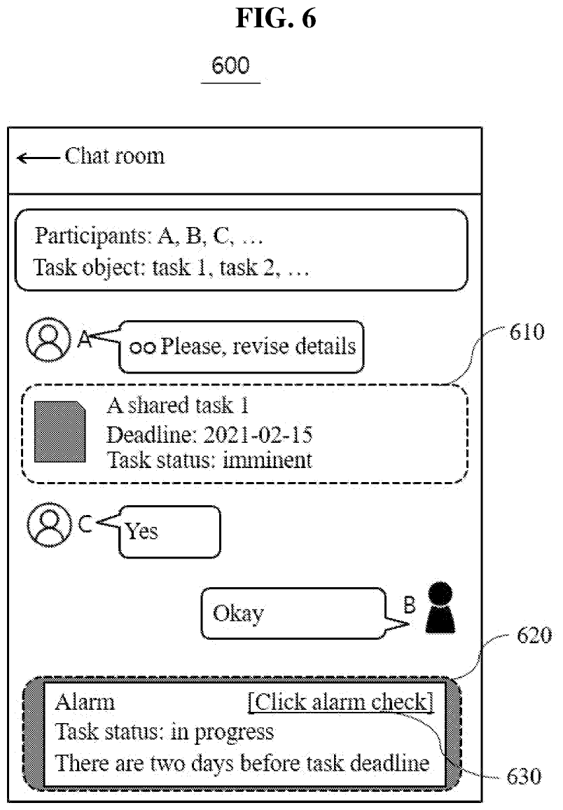

FIG. 6 is a view illustrating a procedure in which the notification condition customized message processing device of FIG. 1 provides an alarm chat message to a corresponding chat room through a user terminal.

In FIG. 6, the notification condition customized message processing device 110 may provide a chat room 600 associated with the corresponding user terminal 120 through the user terminal 120, generate a related task object 610 in the chat room or change a progress status, and provide a related alarm chat message 620 to the user terminal 120 through a process of adding the alarm chat message 620 to a related message thread in real time. The notification condition customized message processing device 110 may provide the alarm chat message to the chat room immediately after generation of the alarm chat message regardless of task alarm conditions, and provide the alarm chat message 620 including an alarm confirmation request button 630 used to ascertain whether a task handler has checked the alarm chat message 620.

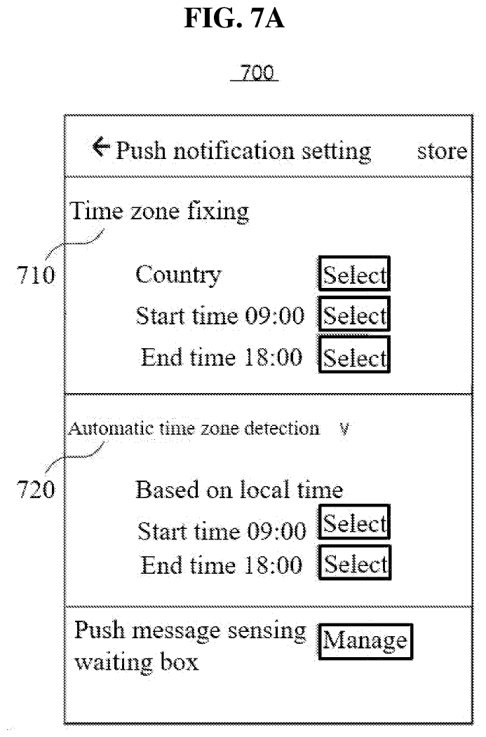

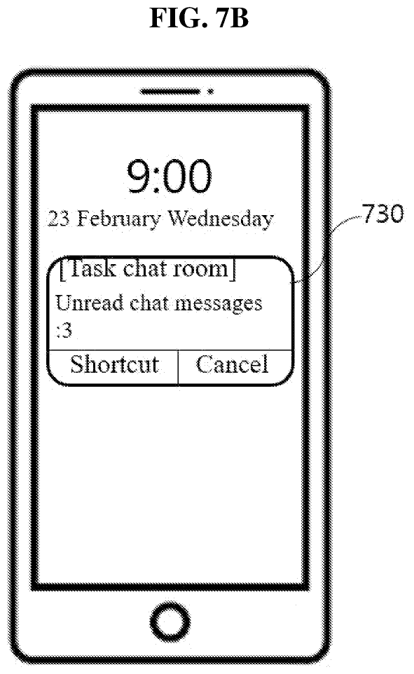

FIG. 7A and FIG. 7B are views illustrating a procedure of setting a notification time condition among individual notification conditions and providing a push message according to an exemplary embodiment.

Referring to FIG. 7A and FIG. 7B, the notification condition customized message processing device 110 may provide a push message setting menu 700 of a user terminal 120 through the user terminal 120. The notification condition customized message processing device 110 may receive a setting request regarding time zone fixing 710 or automatic time zone detection 720 from the user terminal 120 through the push message setting menu 700, and in the process of generating a push message for at least one chat receiving user other than a chat sending user, may detect a notification available time in individual notification conditions of the chat receiving user based on the setting request and provide a push message optimized for the chat receiving user. The notification condition customized message processing device 110 may tag the notification reference time to a chat message, insert the chat message into a notification message list, analyze the notification message list, and provide a push message 730 to the user terminal 120 of the corresponding task handler when the notification reference time is met. For example, if the individual notification time of the corresponding user is set to 9 o'clock, provision of a push message may be delayed such that the push message is provided at 9 o'clock. The push message 730 may include the number of unread chat messages along with description of the chat room such that users participating in the chat can ascertain the number of unread chat messages.

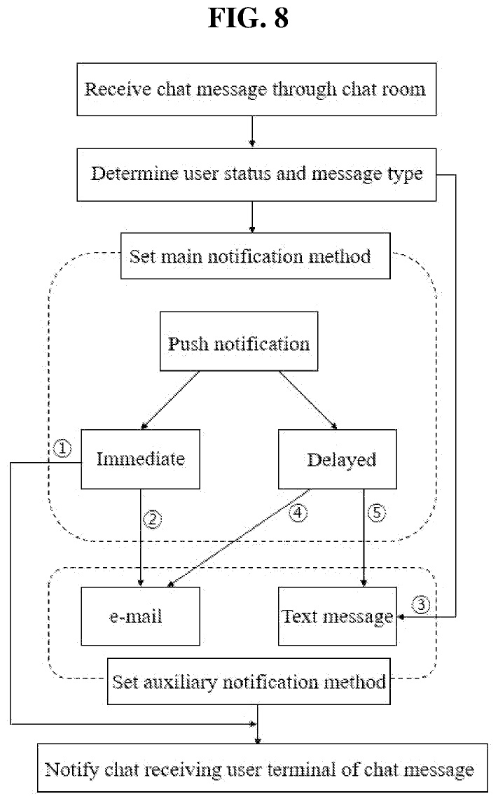

FIG. 8 is a view illustrating an exemplary method of notifying a chat message in the notification condition customized message processing device according to an embodiment.

Referring to FIG. 8, the notification condition customized message processing device 110 may provide a chat room. A plurality of user terminals 120 may perform various types of communication through the chat room. The notification condition customized message processing device 110 may receive a chat message from a chat sending user terminal among the plurality of user terminals 120 through the chat room. Upon reception of the chat message, the notification condition customized message processing device 110 may determine a user status of a corresponding chat receiving user terminal and the type of the received message. The notification condition customized message processing device 110 may determine whether the chat message reception time corresponds to working hours or non-working hours of the user and determine whether the type of the chat message is a general message, a mention message, an object message, or a response message.

The notification condition customized message processing device 110 may set a notification method for the corresponding chat message based on individual notification conditions depending on the user status and message type. As shown in Table 1 described above, the notification condition customized message processing device 110 may select a main notification method for immediate or delayed push notification of a chat message and an auxiliary notification method for notification through sending of e-mail or a text message to notify the chat message. For example, when a general message or an object message is received during working hours of a user, a push message may be immediately provided to the corresponding chat receiving user terminal through a push notification to notify the chat receiving user terminal of the chat message (\textcircled{1}). When a general message or an object message mentioning the user is received during the working hours of the user, a push message may be immediately provided to the corresponding chat receiving user terminal through a push notification and e-mail may be sent to notify the chat receiving user terminal of the chat message (\textcircled{2}). When a general message or an object message is received during non-working hours of the user, a text message may be sent to the corresponding chat receiving user terminal without performing a push notification to notify the chat receiving user terminal of the chat message (\textcircled{3}). When a general message mentioning the user is received during non-working hours of the user, a push notification may be delayed until a notification reference time of the user terminal is met, a push message may be provided, and e-mail may be sent to notify the user of the chat message (\textcircled{4}). When an object message mentioning the user is received during non-working hours of the user, a push notification may be delayed, a push message may be provided, and a text message may be sent to notify the user of the chat message (\textcircled{5}).

While the present disclosure has been described above with reference to the exemplary embodiments, it may be understood by those skilled in the art that the present disclosure may be variously modified and changed without departing from the spirit and scope of the present disclosure disclosed in the claims.

The disclosed technology may have the following effects, but this it does not mean that a particular embodiment should include all of or only the following effects. Therefore, the scope of the disclosed technology should not be construed as being limited thereby.

The notification condition customized message processing device and method according to an embodiment of the present disclosure can provide a notification regarding a chat message in a chat room in accordance with notification conditions for each chat receiving user.

The notification condition customized message processing device and method according to an embodiment of the present disclosure can notify a chat message by setting individual notification conditions depending on a user status and a message type and determining a chat message notification method based on individual notification conditions for each of at least one chat receiving user terminal.

The notification condition customized message processing device and method according to an embodiment of the present disclosure can delay notification of a chat message during time other than working hours by setting individual notification conditions based on working hours of a user and a message type.

What is claimed is:

1. A notification condition customized message processing device comprising:
a chat room opening unit which opens a chat room connected to a plurality of user terminals;
an individual notification condition setting unit which sets individual notification conditions depending on a user status and a message type for each of the plurality of user terminals;
a chat message processing unit which receives a chat message from a chat sending user terminal among the plurality of user terminals through the chat room and inserts the chat message into a message thread associated with the chat room;
a chat message notification method determining unit which determines at least one chat receiving user terminal among the plurality of user terminals and determines a notification method for the chat message based on individual notification conditions for each of the at least one chat receiving user terminals; and
a chat message notification unit which notifies each of the at least one chat receiving user terminals of the chat message through the chat message notification method.

2. The notification condition customized message processing device of claim 1, wherein the individual notification condition setting unit converts a notification available time in the individual notification conditions into a reference time zone based on a time zone to generate a notification reference time, tags the notification reference time to the chat message, and inserts the chat message into a notification message list.

3. The notification condition customized message processing device of claim 2, wherein the individual notification condition setting unit brings a time zone of a corresponding chat receiving user terminal in the process of conversion.

4. The notification condition customized message processing device of claim 2, wherein the individual notification condition setting unit analyzes the notification message list and delays provision of the chat message until the notification reference time is met.

5. The notification condition customized message processing device of claim 1, wherein the individual notification condition setting unit sets the individual notification conditions by determining the user status based on user's working hours and determining the message type based on a general message, a mention message, an object message, or a response message.

6. The notification condition customized message processing device of claim 1, wherein the individual notification condition setting unit sets the individual notification conditions based on the number of unread chat messages in the chat room.

7. The notification condition customized message processing device of claim 1, wherein the chat message processing unit immediately provides the chat message to the chat room regardless of the individual notification conditions.

8. The notification condition customized message processing device of claim 1, wherein the chat message notification method determining unit determines a main notification method and an auxiliary notification method for the chat message based on the individual notification conditions, wherein the main or auxiliary notification method is optional.

9. The notification condition customized message processing device of claim 2, wherein the chat message notification method determining unit sets whether a push notification is present and whether a push notification is delayed as the main notification method and sets whether a text message based on cellular transmission is sent and whether an e-mail is sent as the auxiliary notification method.

10. The notification condition customized message processing device of claim 9, wherein the chat message notification method determining unit includes the number of unread chat messages along with description of the chat room in a push message through the push notification.

11. The notification condition customized message processing device of claim 1, wherein the individual notification condition setting unit sets individual task alarm conditions for each of at least one task object composed of a task orderer, a task handler, details of a task, a task status, and a task deadline in the message thread.

12. The notification condition customized message processing device of claim 11, wherein the individual notification condition setting unit sets the individual task alarm conditions based on at least one of a no-change time of the task status with respect to each of the at least one task object and a remaining time of the task deadline.

13. The notification condition customized message processing device of claim 11, wherein the chat message notification method determining unit updates the individual task alarm conditions such that the task handler is continuously notified of the at least one task object until the task status is completed.

14. A notification condition customized message processing method comprising:
a chat room opening step for opening a chat room connected to a plurality of user terminals;
an individual notification condition setting step for setting individual notification conditions depending on a user status and a message type for each of the plurality of user terminals;
a chat message processing step for receiving a chat message from a chat sending user terminal among the plurality of user terminals through the chat room and inserting the chat message into a message thread associated with the chat room;
a chat message notification method determining step for determining at least one chat receiving user terminal among the plurality of user terminals and determining a notification method for the chat message based on individual notification conditions for each of the at least one chat receiving user terminals; and
a chat message notification step for notifying each of the at least one chat receiving user terminals of the chat message through the chat message notification method.

15. The notification condition customized message processing method 14, wherein the individual notification condition setting step comprises a step of converting a notification available time in the individual notification conditions into a reference time zone based on a time zone to generate a notification reference time, tagging the notification reference time to the chat message, and inserting the chat message into a notification message list.

16. The notification condition customized message processing method 14, wherein the individual notification condition setting step comprises a step of setting the individual notification conditions by determining the user status based on user's working hours and determining the message type based on a general message, a mention message, an object message, or a response message.

17. The notification condition customized message processing method 14, wherein the individual notification condition setting step comprises a step of setting individual task alarm conditions for each of at least one task object composed of a task orderer, a task handler, details of a task, a task status, and a task deadline in the message thread.
